(19) United States
(12) Patent Application Publication
(10) Pub. No.: US 2014/0141746 A1
(43) Pub. Date: May 22, 2014

(54) SUBSCRIBER IDENTITY SYSTEMS, SERVERS, METHODS FOR CONTROLLING A SUBSCRIBER IDENTITY SYSTEM, AND METHODS FOR CONTROLLING A SERVER

(71) Applicants: Khiam Yong Tan, Singapore (SG); Vara Venkata Satya Prasad Golla, Singapore (SG)

(72) Inventors: Khiam Yong Tan, Singapore (SG); Vara Venkata Satya Prasad Golla, Singapore (SG)

(21) Appl. No.: 13/682,508

(22) Filed: Nov. 20, 2012

(51) Int. Cl. H04W 12/00

(52) U.S. Cl. CPC H04W 12/00
USPC 455/411

(57) ABSTRACT

A subscriber identity system may be provided. The subscriber identity system may include: at least one Virtual SIM Host; a memory configured to store an authorization certificate; a transmitter configured to transmit to a server a request for Virtual SIM Essence, the request including data based on the authorization certificate; a receiver configured to receive from the server the Virtual SIM Essence.

### TECHNICAL FIELD

Aspects of this disclosure relate generally to subscriber identity module, servers, methods for controlling a subscriber identity module, and methods for controlling a server.

### BACKGROUND

A subscriber identity module (SIM) is provided in a mobile radio communication device, for example a mobile station (MS) or a user equipment (UE). A SIM holds personalized data for that specific SIM.

### SUMMARY

A subscriber identity system may include: at least one Virtual SIM Host; a memory configured to store an authorization certificate; a transmitter configured to transmit to a server a request for Virtual SIM Essence, the request including data based on the authorization certificate; a receiver configured to receive from the server the Virtual SIM Essence using an asymmetric transmission (for example using a public key infrastructure (PKI))

A server may include: a memory configured to store Virtual SIM Essence; a receiver configured to receive from a subscriber identity system a request for the Virtual SIM Essence, the request including data based on a certificate; an authentication circuit configured to evaluate the data based on the certificate; and a transmitter configured to transmit based on the evaluation of the data based on the certificate to the subscriber identity system the Virtual SIM Essence.

A method for controlling a subscriber identity system may include: storing an authorization certificate; transmitting to a server a request for Virtual SIM Essence, the request including data based on the authorization certificate; receiving from the server the Virtual SIM Essence using an asymmetric transmission (for example using a public key infrastructure (PKI)).

A method for controlling a server may include: storing Virtual SIM Essence; receiving from a subscriber identity system a request for the Virtual SIM Essence, the request including data based on a certificate; evaluating the data based on the certificate; and transmitting based on the evaluation of the data based on the certificate to the subscriber identity system the Virtual SIM Essence.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various aspects of this disclosure. In the following description, various aspects of this disclosure are described with reference to the following drawings, in which:

FIG. 1 shows a subscriber identity system;

FIG. 2 shows a subscriber identity system with an authorization file receiver, a de-association request circuit, and a VSE (Virtual SIM Essence) loading determination circuit;

FIG. 3 shows a mobile radio communication device;

FIG. 4 shows a server;

FIG. 5 shows a server with a transmission determiner;

FIG. 6 shows a flow diagram illustrating a method for controlling a subscriber identity system; and

FIG. 7 shows a flow diagram illustrating a method for controlling a server.

### DESCRIPTION

The following detailed description refers to the accompanying drawings that show, by way of illustration, specific details and aspects of the disclosure in which the invention may be practiced. These aspects of the disclosure are described in sufficient detail to enable those skilled in the art to practice the invention. Other aspects of the disclosure may be utilized and structural, logical, and electrical changes may be made without departing from the scope of the invention. The various aspects of the disclosure are not necessarily mutually exclusive, as some aspects of the disclosure may be combined with one or more other aspects of the disclosure to form new aspects of the disclosure.

The terms “coupling” or “connection” are intended to include a direct “coupling” or direct “connection” as well as an indirect “coupling” or indirect “connection”, respectively.

The word “exemplary” is used herein to mean “serving as an example, instance, or illustration”. Any aspect of this disclosure or design described herein as “exemplary” is not necessarily to be construed as preferred or advantageous over other aspect of this disclosure or designs.

The term “protocol” is intended to include any piece of software, that is provided to implement part of any layer of the communication definition.

A radio communication device may be an end-user mobile device (MD). A radio communication device may be any kind of radio communication terminal, mobile radio communication device, mobile telephone, personal digital assistant, mobile computer, or any other mobile device configured for communication with another radio communication device, a mobile communication base station (BS) or an access point (AP) and may be also referred to as a User Equipment (UE), a mobile station (MS) or an advanced mobile station (advanced MS, AMS), for example in accordance with IEEE 802.16m.

A radio base station may be a radio base station operated by a network operator (which may also be referred to as a legacy base station), e.g. a NodeB or an eNodeB, or may be a home base station, e.g. a Home NodeB, e.g. a Home (e)NodeB. In an example, a ‘Home NodeB’ may be understood in accordance with 3GPP (Third Generation Partnership Project) as a trimmed-down version of a cellular mobile radio base station optimized for use in residential or corporate environments (e.g., private homes, public restaurants or small office areas). Femto-Cell Base Stations (FC-BS) may be provided in accordance with a 3GPP standard, but may also be provided for any other mobile radio communication standard, for example for IEEE 802.16m.

The subscriber identity system may include a memory which may for example be used in the processing carried out by the subscriber identity system. The radio communication device may include a memory which may for example be used in the processing carried out by the radio communication device. The server may include a memory which may for example be used in the processing carried out by the server. A memory may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, for example, a floating gate memory, a charge trapping memory, an MRAM (Magnetoresistive Random Access Memory) or a PCRAM (Phase Change Random Access Memory).

As used herein, a “circuit” may be understood as any kind of a logic implementing entity, which may be special purpose circuitry or a processor executing software stored in a memory, firmware, or any combination thereof. Furthermore, a “circuit” may be a hard-wired logic circuit or a programmable logic circuit such as a programmable processor, for example a microprocessor (for example a Complex Instruction Set Computer (CISC) processor or a Reduced Instruction Set Computer (RISC) processor). A “circuit” may also be a processor executing software, for example any kind of computer program, for example a computer program using a virtual machine code such as for example Java. Any other kind of implementation of the respective functions which will be described in more detail below may also be understood as a “circuit”. It may also be understood that any two (or more) of the described circuits may be combined into one circuit.

Description is provided for devices, and description is provided for methods. It will be understood that basic properties of the devices also hold for the methods and vice versa. Therefore, for sake of brevity, duplicate description of such properties may be omitted.

It will be understood that any property described herein for a specific device may also hold for any device described herein. It will be understood that any property described herein for a specific method may also hold for any method described herein.

Devices (for example a system) and methods may be provided to enable use of both physical SIM cards and virtual SIM cards.

Devices (for example a system) and methods to move Virtual SIM Essence from a UE to another UE may be provided.

Current physical SIM card may occupy valuable space and may add weight to mobile phones. Physical SIM card may not be transmitted electronically adding to distribution cost.

A SIM card (which may also be referred to as a UICC (Universal Integrated Circuit Card)) may include a SIM operating system or a kernel, which may be configured by parameters described in standards and customized by network operators. The process of injecting the data and customization for an operator in a SIM card may be called Personalization. The data may be referred to as perso (or personalization) data, and it may include network-specific information used to authenticate and identify subscribers on the network. The most important of these may be the ICCID (Integrated Circuit Card Identifier), IMSI (International Mobile Subscriber Identity), Authentication Key (Ki), Local Area Identity (LAI) and Operator-Specific Emergency Number. The SIM also may store other carrier-specific data such as the SMSC (Short Message Service Center) number, Service Provider Name (SPN), Service Dialing Numbers (SDN), Advice-Of-Charge parameters, Value Added Service (VAS) applications and preferred networks for roaming.

In the case of embedded UICC (eUICC) there may be the need to be able to support multiple network operators. This may mean multiple operators at the same time or the option to change the subscription to a different operator remotely. The subscription may be changed and multiple subscriptions may be supported in parallel. The personalization of the SIM card may be broken into two phases. Data concerning operator specific profiles may be loaded in the second phase and normally over the air. A master key may be injected in the first phase of personalization process and having this master key may enable the second phase to be performed. The ownership of this master key may be under debate. Network operators, mobile phone manufacturers and the TSM (Trusted Secure Manager) all may desire to be controlling the master key. Consensuses may have not been reached so far on who holds the master key at 3GPP (3rd Generation Partnership Project). The master key may be generated by the SIM vendor, but may eventually be transferred to the owner (which may be under debate) after personalization. This impasse may prevent the eUICC from being used on mobile phones.

The virtual SIM card described herein may function like a physical SIM in all aspect.

This Virtual SIM card may include two parts, a Virtual SIM Host (VSH) and a Virtual SIM Essence (VSE).

The Virtual SIM Host may include a secure operating environment that is able to fulfill all the function of a physical SIM card (for example like a raw physical SIM before loading personalisation data). Once VSH is loaded with VSE, it may become a fully functional SIM. VSH is not limited to one VSE.

The Virtual SIM Essence may include a collection of secured bits that may include the personalisation of the SIM card (for example like in the case for a physical SIM). The system may be designed such that any instance of VSE is assigned to one and only one instance of VSH.

Delivery of the VSE to VSH may involve an authorization server and a VSE server. The authorization server may authenticate the user in multitude of ways known as such. It then may issue an authorization file including the address and certificate of the VSE server and authorization packet for the VSE server. This file may be delivered to the user in multitude of ways known as such. This file may be loaded into the VSH. The VSH may establish a secure connection to the VSE server. Mutual authentication may take place using certificate of the server and certificate issued by VSH supplier. An authorization packet may be sent from VSH to VSE server and the server may send the VSE to VSH as authorized by the authorization packet.

Various devices and methods may be provided which allow different VSE to be loaded to the VSH. The VSE may take the place of the physical SIM card (and thus, the VSH may also be referred to as a subscriber identity module), and distribution of the authorization file may take the place of distribution of physical SIM card and may allow all existing business model to work. It may be transferred by electronic means which may allow saving in distribution cost and may enable new business models that used to be limited by the need for physical distribution of the physical SIM card.

It may solve the problem of size and weight, may allow electronic distribution and compared to eUICC this solution may not introduce the problem concerning ownership of the master key.

The virtual SIM's essence may be a set of bits encrypted by a secret key that may only exist inside the base band chip. Using encryption, these bits may be stored in any storage media. In this encrypted form, they may be uniquely tied to a single UE. Multiple SIMs may be stored in any storage media accessible to the UE. When it is loaded on the baseband's secured virtual SIM operating environment, a virtual SIM entity may be in operation and it may serve all the function of a physical SIM card. It may be understood that besides providing the Virtual SIM Host (VSH) on the baseband (which may refer to the chip that hosts the digital portion of a modem of a mobile radio communication device), but the virtual SIM Host (VSH) may also be provided on a separate chip.

Delivery of the virtual SIM Essence (VSE) may involve three entities 1) UE's Subscriber Identity System (SIS) 2) A Virtual SIM Essence (VSE) server 3) An authorization server. The authorization server may authenticate the user in multitude of ways known as such. It then may issue an authorization file including the address and certificate of the SIM Essence server and authorization packet for the Virtual SIM Essence server. This file may be delivered to the user in multitude of ways known as such. This file may be loaded into the Subscriber Identity System. The Subscriber Identity System may establish a secure connection to the Virtual SIM Essence server. Mutual authentication may take place using the certificate of the server and the certificate issued by Subscriber Identity System supplier. The authorization packet may be sent from the Subscriber Identity System to the Virtual SIM Essence server and the server may send the Virtual SIM Essence as authorized by the packet to the Subscriber Identity System.

For the case of eUICC, there may only be one SIM and it may be embedded in the manufacturing process of the UE. The owner ship of the master key may be contested. The personalisation process may be desired to be modified and split into two phases, wherein partial provisioning may take place in the eUICC factory where the master key is placed and when a carrier is decided, the rest of the personalisation may take place. The entity that controls the master key may be desired to be involved to enable the personalisation process and/or change of carrier. Various devices and methods may be provided which allow different Virtual SIM Essence to be loaded on the Virtual SIM Host, so that ownership of the master key may not be conferring more power that in the case of physical SIM card.

A device or system may be provided which may include a secure operating environment that is able to fulfill all the function of a physical SIM card, for example secure storage, tamperproof code, and secure execution of code. All these facilities may be hosted on the baseband chip or on the application processor or a dedicated chip.

Two secrets may be stored on the baseband chip: A certificate issued by a manufacturer of the Virtual SIM Host (VSH) and a unique key for secure storage. This encryption key may be generated like a UUID and no copy may be kept elsewhere. Any data encrypted by this secret key may only be decoded by this single VSH (or a single baseband chip).

The Virtual SIM Host implemented on the baseband may provide the full functionality of what a physical SIM does. The personalization of the SIM may be delivered by a Virtual SIM Essence server via a secure connection established between VSH and VSE server using any of a plurality of methods with the certificate of the VSH manufacturer and certificate of the VSE server supplied in an authorization file. Once the secure connection is established, the authorization packet may be sent to the VSE server. This authorization packet may include the information needed by the server to transfer authorized VSE to the VSH. The VSE may include the full SIM personalisation data that may normally be put on a physical SIM card. When VSH received the VSE, it may encrypt this data using its secret key with an encryption algorithm and once encrypted, it may be stored on any non-volatile storage system that is available to the VSH From here on, the functionality of this SIM may be similar or identical to a SIM on a physical SIM card. The encrypted VSE file may be considered like a SIM card like entity. Multiple files may exist in the system. Selecting a VSE file may be like selecting a SIM card to be put into the SIM card connector.

In the following, an example for authorization file delivery will be described. A customer may go to a phone shop to sign up for a plan with an operator, the staff at the counter may go through the normal process of verifying his identity, take his credit card information etc. In the normal process (for a physical SIM card), the staff would take a physical SIM card from the stockpile and associate the ICCID with the account and put the SIM card into the phone for the customer. Instead of that, the staff may use his computer terminal to request for an authorization file. The computer terminal may take an ICCID and associated authorization file from the electronic stockpile and may issue it to this customer. The ICCID may be associated with the customer like usual. This authorization file may be transferred to the phone using a USB cable.

The authorization file may be pre-generated by the vendor of physical SIM cards. The operation may be very similar to the physical SIM card personalization. The only difference may be that instead of a physical stock pile now there may be an electronic stock pile of authorization file and ICCIDs associated with the file. This vendor may also operate the VSE server. The vendor may generate the personalisation data just like they would a physical SIM card. They may generate an associated authorization packet that allows VSH to retrieve this data. The authorization file which includes the address of the VSE server, the certificate of the VSE server for establishment and authentication of secure connection and authorization packet associated with the ICCID may be delivered to the carrier. The carrier may use these file very much as they would with the physical SIM cards and the electronic form allow them to use it in ways that was not possible with physical SIM cards.

To save on chip nonvolatile memory, the SIM personalization data may be stored on system flash with encryption. This may allow to support many Virtual SIM Essences with reasonable cost since system flash is low priced in comparison with on-chip-memory. However this may post a problem if a virtual SIM card is to be transferred from one UE to another. If someone made a copy of the data stored on the external flash, perform a transfer (if such a function is enabled) to another UE and restore the copy back to the flash, there may be duplication of virtual SIM card, which may not be permissible.

Even if the personalization data is not stored on the flash, there may arise the question of when to delete it. If it would be deleted before sending it and should some problem occur during the process of sending, the virtual SIM card would be lost. If it was sent first and deleted after the transfer, if the process is interrupted and the deletion did not occur, a duplication problem may arise.

One solution to the above problem may be to connect to the VSE server using virtual SIM and authorization file. It may be signaled to the VSE server to invalidate previously issued VSE by changing the key Ki (subscriber key) associated to the SIM. After this key is changed, the VSE may be flagged as not yet issued and the authorization file may be used again to get VSE issued to any UE.

In another way, each SIS may have a unique SISID (SIS identifier). This SISID may be associated to ICCID on the VSE server when the VSE is to be issued to the SIS. In the beginning, the SISID associated to ICCID on the VSE server may be null. This may allow any SIS to receive the VSE with just the authorization file. Once the ICCID is associated with SISID, the VSE may only be re-issued to SIS that has SISID that matched the entry in the database.

ICCIDs of all SIM that can be used on the UE may be stored in internal secure NVM (non-volatile memory) on the baseband. If the associated ICCID is missing on chip, the VSE file may not be loaded. So by removing this entry, even a trick described above may not be used to create a duplicated virtual SIM.

The SIM may be transferred to another UE. The first step may be to delete ICCID from the list of available ICCIDs described above and to unload the VSE from the SIS. Next, a connection to the VSE server may be established using the authorization file. It may be signaled to the VSE server to change the SISID associated to the ICCID to null. The VSE server may only allow the VSE with the SISID that is associated to the ICCID in its database to perform this step. If this step fails, the SIM may not be lost as the SISID may still be associated and VSE may be re issued to the SIS with this SISID.

After the above step, the authorization file may be used by another UE.

To reduce the size of internal secure NVM required to store the list of ICCIDs of the VSE that can be loaded, this list may be stored encrypted together with an index that may change every time the list is changed. This index may be stored in the secure NVM instead of the whole list. This index may be desired to match the index in the file (for example in order to allow loading of the list). This may prevent the copy and restore hack.

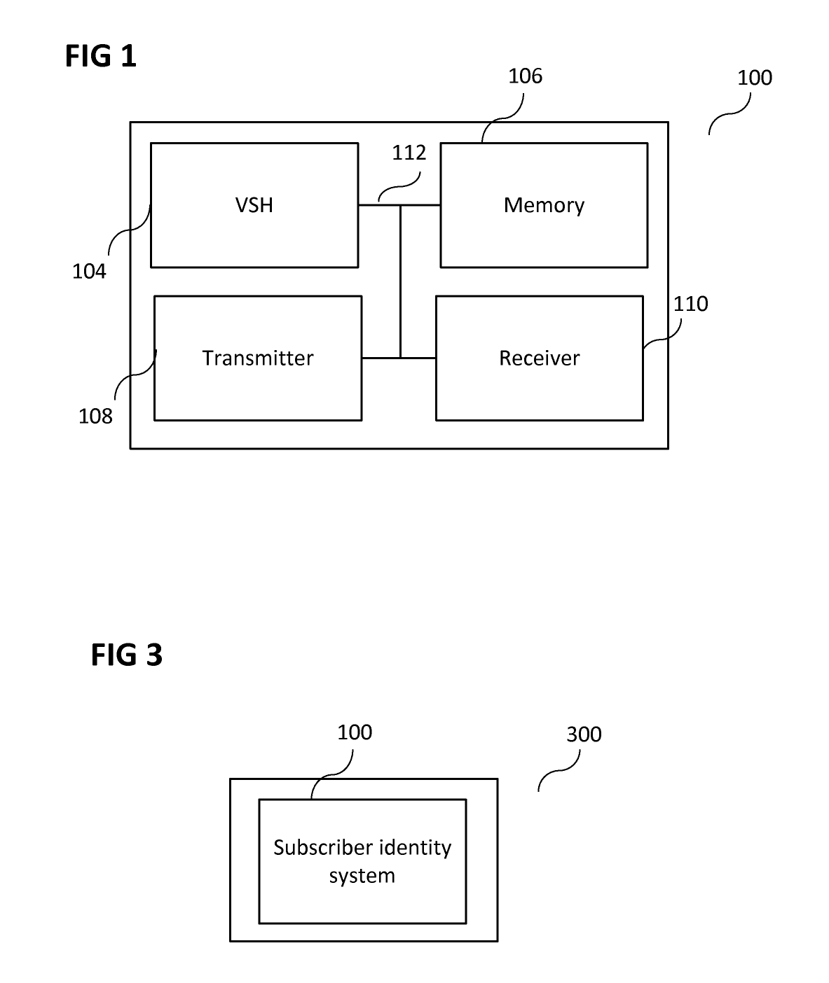

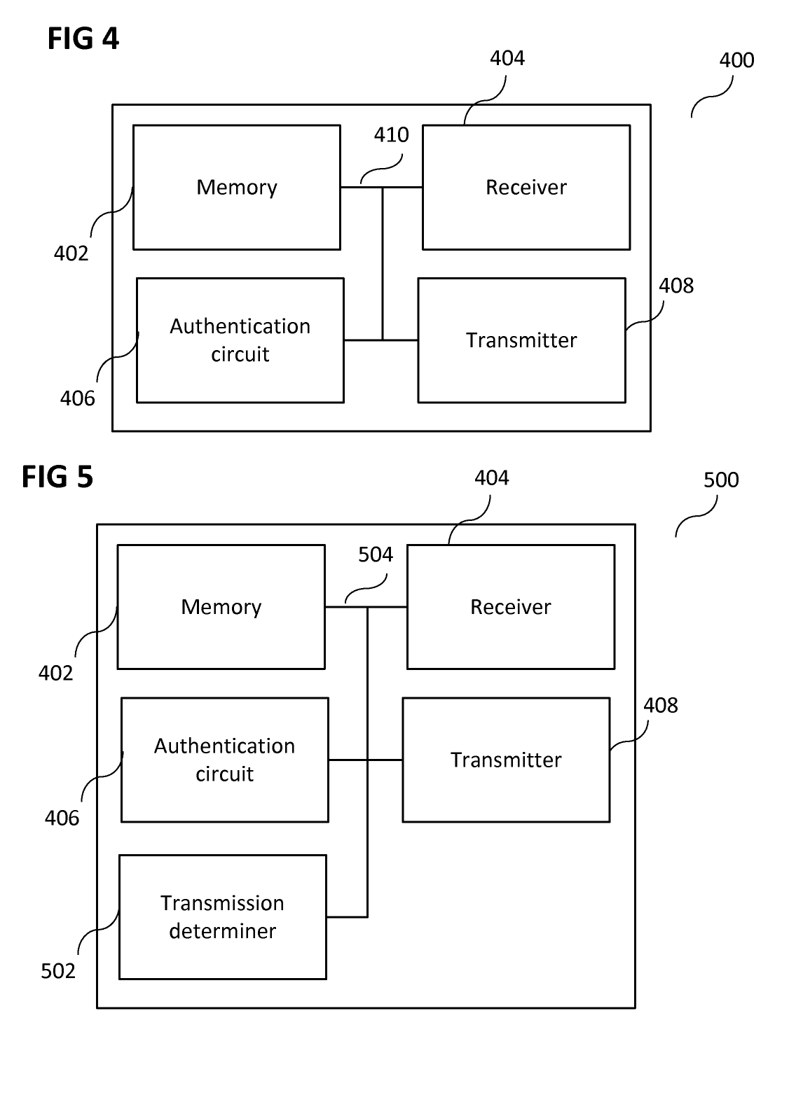

FIG. 1 shows a subscriber identity system 100. The subscriber identity system may include at least one Virtual SIM Host 104. The subscriber identity system 100 may further include a memory 106 configured to store an authorization certificate The subscriber identity system 100 may further include a transmitter 108 configured to transmit to a server (not shown in FIG. 1, for example a server like will be described below with reference to FIG. 4) a request for Virtual SIM Essence (wherein the Virtual SIM Essence may also be referred to as VSE, like described above). The request may include data based on the authorization certificate. The subscriber identity system 100 (for example the VSH 104) may further include a receiver 110 configured to receive from the VSE server the Virtual SIM Essence using an asymmetric transmission (for example using a public key infrastructure (PKI)). According to various embodiments, the VSH 104 may further include an encryption circuit (not shown) configured to encrypt the received Virtual SIM Essence using a secret key stored in the memory. The VSH 104, the memory 106, the transmitter 108, and the receiver 110 may be coupled with each other, for example via a connection 112, for example an optical connection or an electrical connection, such as for example a cable or a computer bus or via any other suitable electrical connection to exchange electrical signals.

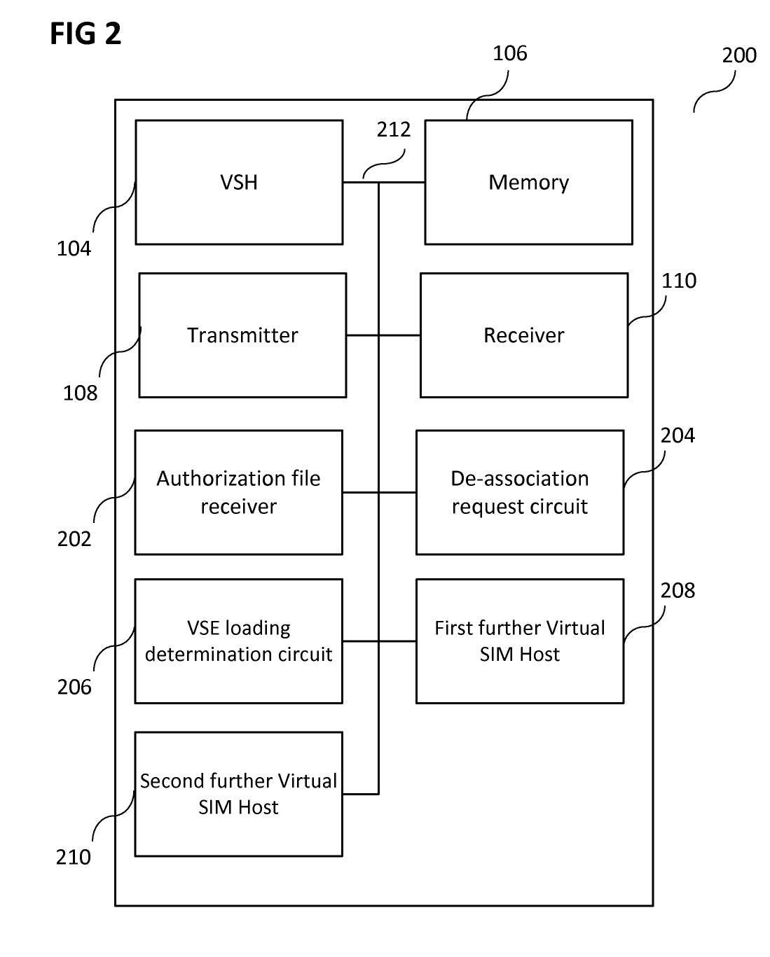

FIG. 2 shows a subscriber identity system 200. The subscriber identity system 200 may, similar to the subscriber identity system 100 of FIG. 1, include at least one VSH 104. The subscriber identity system 200 may, similar to the subscriber identity system 100 of FIG. 1, further include a memory 106. The subscriber identity system 200 may, similar to the subscriber identity system 100 of FIG. 1, include a transmitter 106. The subscriber identity system 200 may, similar to the subscriber identity system 100 of FIG. 1, include a receiver 108. The subscriber identity system 200 may further include an authorization file receiver 202, like will be described below. The subscriber identity system 200 may further include a de-association request circuit 204, like will be described below. The subscriber identity system 200 may further include a VSE configuration loading determination circuit 206, like will be described below. The subscriber identity system 200 may further include a first further Virtual SIM Host 208, like will be described below. The subscriber identity system 200 may further include a second further Virtual SIM Host 210, like will be described below. The memory 102, the transmitter 104, the receiver 106, the encryption circuit 108, the authorization file receiver 202, the de-association request circuit 204, the VSE loading determination circuit 206, the first further Virtual SIM Host 208, and the second further Virtual SIM Host 210 may be coupled with each other, for example via a connection 212, for example an optical connection or an electrical connection, such as for example a cable or a computer bus or via any other suitable electrical connection to exchange electrical signals.

The authorization file receiver 202 may be configured to receive from another server (not shown in FIG. 1) an authorization file. The authorization file may include at least one of an address of the server, a certificate of the server, and an authorization packet for the server.

The request may include or may be the authorization file.

The server may include or may be a Virtual SIM Essence server. The other server may include or may be an authorization server.

The memory 106 may be further configured to store an identifier of the Subscriber Identity System 200.

The de-associating request circuit 204 may be configured to transmit to the server a request for de-associating the identifier.

The Virtual SIM Essence may include or may be an identifier of the Virtual SIM Essence.

The VSE loading determination circuit 206 may be configured to determine whether the Virtual SIM Essence may be applied based on the identifier of the Virtual SIM Essence.

The first further Virtual SIM Host 208 and the second further Virtual SIM Host 210 may be generic hardware (HW) and software (SW) required to perform the SIM function, when loaded with the personalization data (for example VSE). Each Virtual SIM Host may provide or may be one virtual SIM. Each Virtual SIM Essence may require one Virtual SIM Host. Although three Virtual SIM Host are shown in FIG. 2, there may be only one virtual SIM engine, or there also may be two or more than two virtual SIM engines. There may be mobile phones which support multiple SIM. Virtual SIM Hosts may share the physical resources like CPU (central processing unit), ROM (read only memory), etc.

FIG. 3 shows a mobile radio communication device 300. The mobile radio communication device 300 may include the subscriber identity system 100 (or 200) as described above.

FIG. 4 shows a server 400. The server 400 may include a memory 402 configured to store Virtual SIM Essence. The server 400 may further include a receiver 404 configured to receive from a subscriber identity system (not shown in FIG. 4, for example the subscriber identity system described above in FIG. 1 or FIG. 2) a request for the Virtual SIM Essence. The request may include or may be data based on a certificate (for example an authentication certificate). The server 400 may further include an authentication circuit 406 (for example an authentication engine) configured to evaluate the data based on the certificate. The server 400 may further include a transmitter 408 configured to transmit based on the evaluation of the data based on the certificate to the subscriber identity system the Virtual SIM Essence. The memory 402, the receiver 404, the authentication circuit 406, and the transmitter 408 may be coupled with each other, for example via a connection 410, for example an optical connection or an electrical connection, such as for example a cable or a computer bus or via any other suitable electrical connection to exchange electrical signals.

The memory 402 may further be configured to store an association of the Virtual SIM Essence with an SIS.

FIG. 5 shows a server 500. The server 500 may, similar to the server 400 of FIG. 4, include a memory 402. The server 500 may, similar to the server 400 of FIG. 4, include a receiver 404. The server 500 may, similar to the server 400 of FIG. 4, include an authentication circuit 406. The server 500 may, similar to the server 400 of FIG. 4, include a transmitter 408. The server 500 may further include a transmission determiner 502, like will be described below. The memory 402, the receiver 404, the authentication circuit 406, the transmitter 408, and the transmission determiner 502 may be coupled with each other, for example via a connection 504, for example an optical connection or an electrical connection, such as for example a cable or a computer bus or via any other suitable electrical connection to exchange electrical signals.

The transmission determiner 502 may be configured to determine whether to transmit the Virtual SIM Essence based on the association.

The server 500 may include or may be a virtual SIM Essence server.

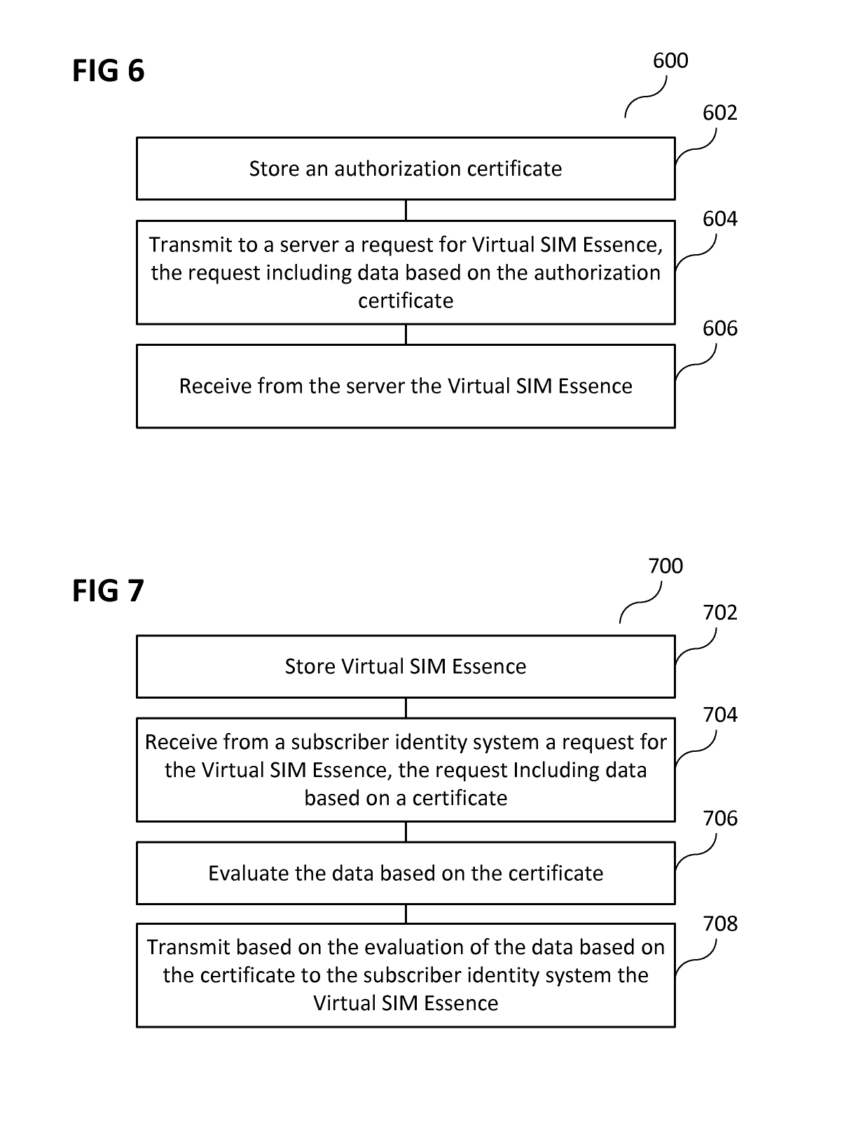

FIG. 6 shows a flow diagram 600 illustrating a method for controlling a subscriber identity system. In 602, a memory of the subscriber identity system may store an authorization certificate. In 604, a transmitter of the subscriber identity system may transmit to a server a request for Virtual SIM Essence. The request may include data based on the authorization certificate. In 606, a receiver of the subscriber identity system may receive from the server the Virtual SIM Essence using an asymmetric transmission (for example using a public key infrastructure (PKI)). According to various embodiments, an encryption circuit of the subscriber identity system may encrypt the received Virtual SIM Essence using the secret key.

The method may further include receiving from another server an authorization file. The authorization file may include at least one of an address of the server, a certificate of the server, and an authorization packet for the server.

The request may include or may be the authorization file.

The server may include or may be a Virtual SIM Essence server. The other server may include or may be an authorization server.

The method may further include storing an identifier of the VSE.

The method may further include transmitting to the server a request for de-associating the identifier.

The Virtual SIM Essence may include or may be an identifier of the Virtual SIM Essence.

The method may further include determining whether the Virtual SIM Essence may be applied based on the identifier of the Virtual SIM Essence.

FIG. 7 shows a flow diagram 700 illustrating a method for controlling a server. In 702, a memory of the server may store Virtual SIM Essence. In 704, a receiver of the server may receive from a subscriber identity system a request for the Virtual SIM Essence. The request may include or may be data based on a certificate. In 706, an authentication circuit of the server may evaluating the data based on the certificate. In 708, a transmitter of the server may transmit, based on the evaluation of the data based on the certificate, to the subscriber identity system the Virtual SIM Essence.

The method may further include storing an association of the Virtual SIM Essence with a SIS or SISID.

The method may further include determining whether to transmit the Virtual SIM Essence based on the association.

The server may include or may be a virtual SIM Essence server.

It will be understood that a certificate (for example an authorization certificate) may be used for authentication. The method of authentication does not require the transmission of the certificate itself, instead something derived from the certificate (for example according to a method known as such) is transmitted.

Any reference herein to a Virtual SIM Host may be understood as generally referring to a device, for example a circuit, for example an integrated circuit, which may securely store data related to a mobile radio communication device, for example the International Mobile Subscriber Identity (IMSI) and the related key used to identify and authenticate subscribers on the mobile radio communication device. It will be understood that the term VSH is not restricted to a specific radio access technology. A subscriber identity system may provide functionality of a SIM, which may for example may be the terminology for 2G (second generation) and the term may also be referring to the smart card use to perform this function. For 3G and LTE, there may be a change in terminology to USIM (Universal SIM) which may be the software application running on the UICC (the smart card) that perform this function. Both terms (SIM and UICC) are to be covered by the expression “subscriber identity module” as used herein.

According to various embodiments, the devices and methods as described above may also be used for devices such as the security token issued by banks or IT (information technology) department for two factor authentication (2FA). These may be the standalone devices that may give a number, for example a six digit number, with a press of a button. The purpose may also be to authenticate a person (which may be referred to as a subscriber). They may also be bound by a physical form and often a person may have many of such devices coming from the various banks and IT departments. Compared to a SIM card for a mobile radio communication device, the devices may be extended to furthermore include an optional display and optional input method securely separated from the operating system of the UE and thus may not be compromised by malicious software which might have compromised the operating system of the UE.

Any one of the subscriber identity modules, the mobile radio communication devices or servers described above may be configured according to at least one of the following radio access technologies: a Bluetooth radio communication technology, an Ultra Wide Band (UWB) radio communication technology, and/or a Wireless Local Area Network radio communication technology (for example according to an IEEE 802.11 (for example IEEE 802.11n) radio communication standard)), IrDA (Infrared Data Association), Z-Wave and ZigBee, HiperLAN/2 ((HIgh PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput), Worldwide Interoperability for Microwave Access (WiMax) (for example according to an IEEE 802.16 radio communication standard, for example WiMax fixed or WiMax mobile), WiPro, HiperMAN (High Performance Radio Metropolitan Area Network) and/or IEEE 802.16m Advanced Air Interface, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (for example UMTS (Universal Mobile Telecommunications System), FOMA (Freedom of Multimedia Access), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-SCDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), DataTAC, iDEN (Integrated Digital Enhanced Network), PDC (Personal Digital Cellular), PHS (Personal Handy-phone System), WiDEN (Wideband Integrated Digital Enhanced Network), iBurst, Unlicensed Mobile Access (UMA, also referred to as 3GPP Generic Access Network, or GAN standard).

While the invention has been particularly shown and described with reference to specific aspects of this disclosure, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A subscriber identity system comprising:
at least one Virtual SIM Host;
a memory configured to store an authorization certificate;
a transmitter configured to transmit to a server a request for Virtual SIM Essence,
the request comprising data based on the authorization certificate;
a receiver configured to receive from the server the Virtual SIM Essence using an asymmetric transmission.

2. The subscriber identity system of claim 1, further comprising:
an authorization file receiver configured to receive from another server an authorization file, the authorization file comprising an address of the server, a certificate of the server, and an authorization packet for the server.

3. The subscriber identity system of claim 2,
wherein the request comprises the authorization file.

4. The subscriber identity system of claim 2,
wherein the server comprises a Virtual SIM Essence server, and
wherein the other server comprises an authorization server.

5. The subscriber identity system of claim 1,
the Virtual SIM Host further configured to store an identifier of the VSE.

6. The subscriber identity system of claim 5, further comprising:
a de-associating request circuit configured to transmit to the server a request for de-associating the identifier.

7. The subscriber identity system of claim 1,
wherein the Virtual SIM Essence comprises an identifier of the Virtual SIM Essence.

8. The subscriber identity system of claim 7, further comprising:
a VSE loading determination circuit configured to determine whether the Virtual SIM Essence may be applied based on the identifier of the Virtual SIM Essence.

9. A mobile radio communication device, comprising:
the subscriber identity system of claim 1.

10. A server comprising:
a memory configured to store Virtual SIM Essence;
a receiver configured to receive from a subscriber identity system a request for the Virtual SIM Essence, the request comprising data based on a certificate;
an authentication circuit configured to evaluate the data based on the certificate; and
a transmitter configured to transmit based on the evaluation of the data based on the certificate to the subscriber identity system the Virtual SIM Essence.

11. The server of claim 10,
the memory further configured to store an association of the Virtual SIM Essence with a subscriber identity system.

12. The server of claim 11, further comprising:
a transmission determiner configured to determine whether to transmit the Virtual SIM Essence based on the association.

13. The server of claim 10,
wherein the server comprises a virtual SIM Essence server.

14. A method for controlling a subscriber identity system, the method comprising:
storing an authorization certificate;
transmitting to a server a request for Virtual SIM Essence, the request comprising data based on the authorization certificate;
receiving from the server the Virtual SIM Essence using an asymmetric transmission.

15. The method of claim 14, further comprising:
receiving from another server an authorization file, the authorization file comprising an address of the server, a certificate of the server, and an authorization packet for the server.

16. The method of claim 15,
wherein the request comprises the authorization file.

17. The method of claim 15,
wherein the server comprises a Virtual SIM Essence server, and
wherein the other server comprises an authorization server.

18. The method of claim 14, further comprising:
storing an identifier of the Virtual SIM Essence.

19. The method of claim 18, further comprising:
transmitting to the server a request for de-associating the identifier.

20. The method of claim 14,
wherein the Virtual SIM Essence comprises an identifier of the Virtual SIM Essence.

21. The method of claim 20, further comprising:
determining whether the Virtual SIM Essence may be applied based on the identifier of the Virtual SIM Essence.

22. A method for controlling a server, the method comprising:
storing Virtual SIM Essences;
receiving from a subscriber identity system a request for the Virtual SIM Essence,
the request comprising data based on a certificate;
evaluating data based on the certificate; and
transmitting based on the evaluation of the data based on the certificate to the subscriber identity system the Virtual SIM Essence.

23. The method of claim 22, further comprising:
storing an association of the Virtual SIM Essence with a subscriber identity system.

24. The method of claim 23, further comprising:
determining whether to transmit the Virtual SIM Essence based on the association.

25. The method of claim 22,
wherein the server comprises a Virtual SIM Essence server.
